(19) United States
(12) Patent Application Publication
(10) Pub. No.: US 2026/0296135 A1
(43) Pub. Date: Oct. 1, 2026

(54) VEHICLE CONTROL DEVICE

(71) Applicant: TOYOTA JIDOSHA KABUSHIKI KAISHA, Toyota-shi (JP)

(72) Inventor: Masahito KUDO, Toyota-shi (JP)

(73) Assignee: TOYOTA JIDOSHA KABUSHIKI KAISHA, Toyota-shi (JP)

(21) Appl. No.: 19/457,495

(22) Filed: Jan. 23, 2026

(30) Foreign Application Priority Data
Mar. 28, 2025 (JP) 2025-056327

(51) Int. Cl. B60H 1/00; B60J 3/04; E05F 15/695

(52) U.S. Cl. CPC B60H 1/00742; B60H 1/00778; B60H 1/00835; B60J 3/04; E05F 15/695

(57) ABSTRACT

The control device is configured to execute a dog mode control of operating an air conditioning device of a vehicle in a case where a pet is left in a vehicle in which an occupant is not present. The vehicle includes a window glass that is opened and closed by motor control. The window glass is a dimmable glass of which a light transmittance is changeable by power supply control. The control device includes a storage unit configured to store a set opening degree of a window glass and a set transmittance of the window glass during the execution of the dog mode control, and a controller that executes motor control such that the set opening degree is obtained and executes power supply control such that the set transmittance is obtained in a case where the dog mode control is started.

### CROSS-REFERENCE TO RELATED APPLICATION

This application claims priority to Japanese Patent Application No. 2025-056327 filed on Mar. 28, 2025. The disclosure of the above-identified application, including the specification, drawings, and claims, is incorporated by reference herein in its entirety.

### BACKGROUND

### 1. Technical Field

The present disclosure relates to a vehicle control device.

### 2. Description of Related Art

Japanese Unexamined Patent Application Publication No. 2023-69758 (JP 2023-69758 A) discloses a vehicle dimming control device including an acquisition unit that acquires a usage status of an occupant for at least one of an in-vehicle facility or an electronic device provided in a vehicle cabin, and a controller that controls a light transmittance of a window glass of a vehicle according to the acquired usage status. According to the dimming control device disclosed in JP 2023-69758 A, the light transmittance of the window glass of the vehicle is automatically changed according to a status of the occupant in the vehicle cabin even though the occupant does not perform an operation for changing the light transmittance of the window glass.

### SUMMARY

Meanwhile, in some cases, a pet such as a dog is left in a vehicle in which an occupant is not present. In this case, in a case where a person approaches the vehicle or a noise occurs outside the vehicle, the pet may bark or cry out in response, and the comfort of the pet may be impaired.

A vehicle control device that solves the above-described problem is a vehicle control device configured to execute dog mode control of operating an air conditioning device of a vehicle in which an occupant is not present in a case where a pet is left in the vehicle.

The vehicle includes window glass that is opened and closed via motor control, and

the window glass is dimmable glass of which a light transmittance is changeable via power supply control. The vehicle control device includes:

a storage unit configured to store a set opening degree of the window glass and a set transmittance of the window glass when the dog mode control is being executed; and

a controller configured to execute the motor control such that the set opening degree is obtained and execute the power supply control such that the set transmittance is obtained in a case where the dog mode control is started.

In addition, a vehicle control device that solves the above-described problem is a vehicle control device configured to execute dog mode control of operating an air conditioning device of a vehicle in which an occupant is not present in a case where a pet is left in the vehicle.

The vehicle includes window glass that is opened and closed via motor control. The vehicle control device includes:

a storage unit configured to store an opening degree setting value of the window glass when the dog mode control is being executed; and

a controller configured to execute the motor control such that the opening degree setting value is obtained in a case where the dog mode control is started.

According to the present disclosure, it is possible to contribute to improvement of the comfort of a pet left in a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a vehicle according to one embodiment;

FIG. 2 is a block diagram showing an electric configuration centered on a control device according to one embodiment; and

FIG. 3 is a flowchart showing a processing procedure of a dog mode control according to one embodiment.

### DETAILED DESCRIPTION OF EMBODIMENTS

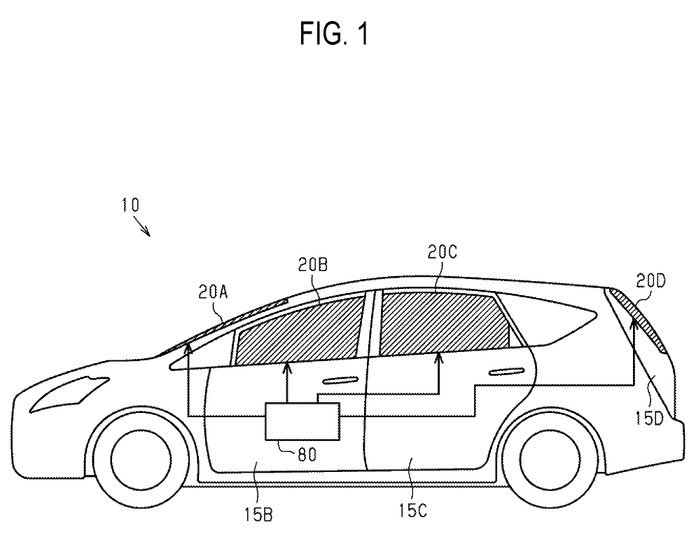

Hereinafter, one embodiment in which the control device of the vehicle is implemented will be described with reference to FIGS. 1-3.

As shown in FIG. 1, a vehicle 10 is, for example, a passenger car, and includes doors and a window glass 20.

The doors include side doors 15B, 15C and a rear door 15D.

The window glass 20 includes a windshield 20A, side glasses 20B, 20C provided in the side doors 15B, 15C, and a rear glass 20D provided in the rear door 15D.

In the following, the side doors 15B, 15C and the rear door 15D may be collectively referred to as doors. In addition, the windshield 20A, the side glasses 20B, 20C, and the rear glass 20D may be collectively referred to as the window glass 20.

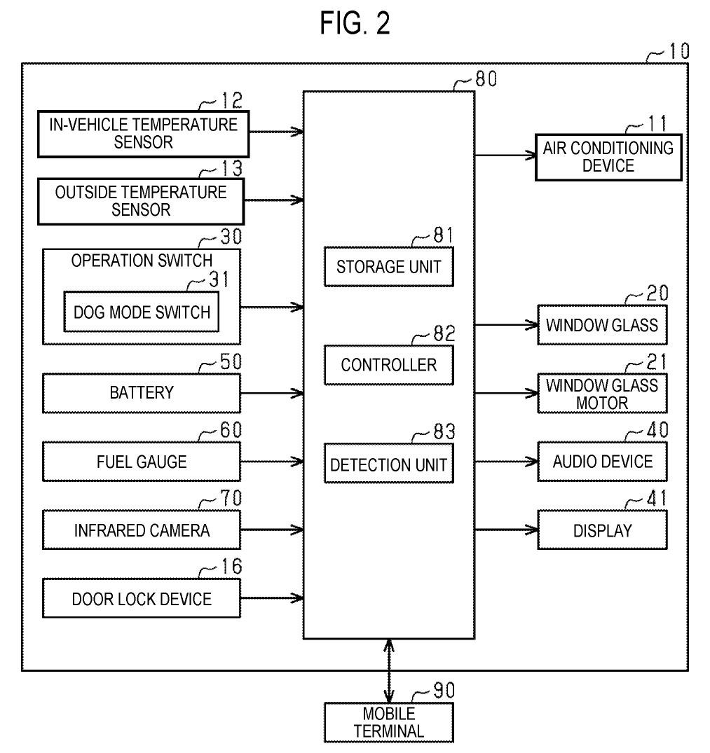

As shown in FIG. 2, the vehicle 10 is provided with an air conditioning device 11, an in-vehicle temperature sensor 12 that measures a temperature in the vehicle, and an outside temperature sensor 13 that measures a temperature outside the vehicle. The air conditioning device 11, the in-vehicle temperature sensor 12, and the outside temperature sensor 13 are electrically connected to a vehicle control device (hereinafter, a control device 80).

The vehicle 10 is provided with a door lock device 16 that locks the doors in a fully closed state. The door lock device 16 is electrically connected to the control device 80.

The window glass 20 is a dimmable glass of which a light transmittance (specifically, a transmittance of visible light and near-infrared light) is changeable by power supply control. The dimmable glass is composed of, for example, an organic EL panel. A window glass motor 21 that opens and closes the side glasses 20B, 20C is provided in the side doors 15B, 15C. The window glass 20 and the window glass motor 21 are electrically connected to the control device 80.

The vehicle 10 is provided with an audio device 40 and a display 41. The audio device 40 includes a storage device such as a hard disk that can store BGM data. The display 41 is provided in, for example, an instrument panel, and functions as a display unit of the air conditioning device 11, a navigation system, the audio device 40, and the like. The display 41 includes a capacitive touch switch. The audio device 40 and the display 41 are electrically connected to the control device 80.

The vehicle 10 is provided with a battery 50 that is configured to supply power to various devices such as the air conditioning device 11, and a fuel gauge 60 that measures a fuel amount in a fuel tank (not shown). The battery 50 and the fuel gauge 60 are electrically connected to the control device 80. The vehicle 10 according to the present embodiment is equipped with an internal combustion engine that can drive a generator that generates power to be charged in the battery 50, but may be a battery electric vehicle that does not include the internal combustion engine. In this case, the fuel gauge 60 can be omitted.

In addition, an infrared camera 70 that detects a movement of a dog that is a pet or measures a body temperature of the dog is provided in the vehicle. The infrared camera 70 is electrically connected to the control device 80.

An operation switch 30 that operates various devices such as the air conditioning device 11 and the audio device 40 is provided in the vehicle. The operation switch 30 is electrically connected to the control device 80. The operation switch 30 includes a touch switch of the display 41.

In addition, the operation switch 30 includes a dog mode switch 31 that performs on and off operations of a dog mode control of operating the air conditioning device 11 of the vehicle 10 in a case where a pet is left in the vehicle in which an occupant is not present. A disposition of the dog mode switch 31 is not particularly limited, but is provided in the instrument panel in the present embodiment. The dog mode switch 31 can also be materialized as the touch switch of the display 41.

The control device 80 is configured to execute the dog mode control in a case where the dog mode switch 31 is turned on.

The control device 80 includes a storage unit 81, a controller 82, and a detection unit 83.

The storage unit 81 is configured to store a set opening degree of the window glass 20 and a set transmittance of the window glass 20 during the execution of the dog mode control. The set opening degree is, for example, a fully closed opening degree. The set opening degree can also be set to an opening degree on an opening side with respect to the fully closed opening degree. In addition, the set transmittance is a value lower than the light transmittance set during vehicle traveling.

The controller 82 executes the motor control of the window glass motor 21 such that the set opening degree is obtained and executes the power supply control of the window glass 20 such that the set transmittance is obtained in a case where the dog mode control is started.

The detection unit 83 is configured to detect that the occupant approaches the vehicle 10. The detection unit 83 according to the present embodiment is configured to detect that the occupant approaches the vehicle 10 in a case where a distance between the vehicle 10 and a mobile terminal 90 carried by the occupant is within a predetermined distance (for example, several tens of meters). The detection unit 83 detects the approach of the mobile terminal 90 by using, for example, short-range wireless communication such as Bluetooth (registered trademark).

In a case where the detection unit 83 detects that the occupant approaches the vehicle 10 during the execution of the dog mode control, the controller 82 executes the power supply control such that the light transmittance of the window glass 20 is higher than the setting value. The light transmittance here is, for example, the light transmittance set during vehicle traveling.

The controller 82 is configured to disable the operation of the operation switch 30 in the vehicle during the execution of the dog mode control.

The controller 82 is configured to stop the power supply to the display 41 and to operate the audio device 40 to play the BGM data during the execution of the dog mode control.

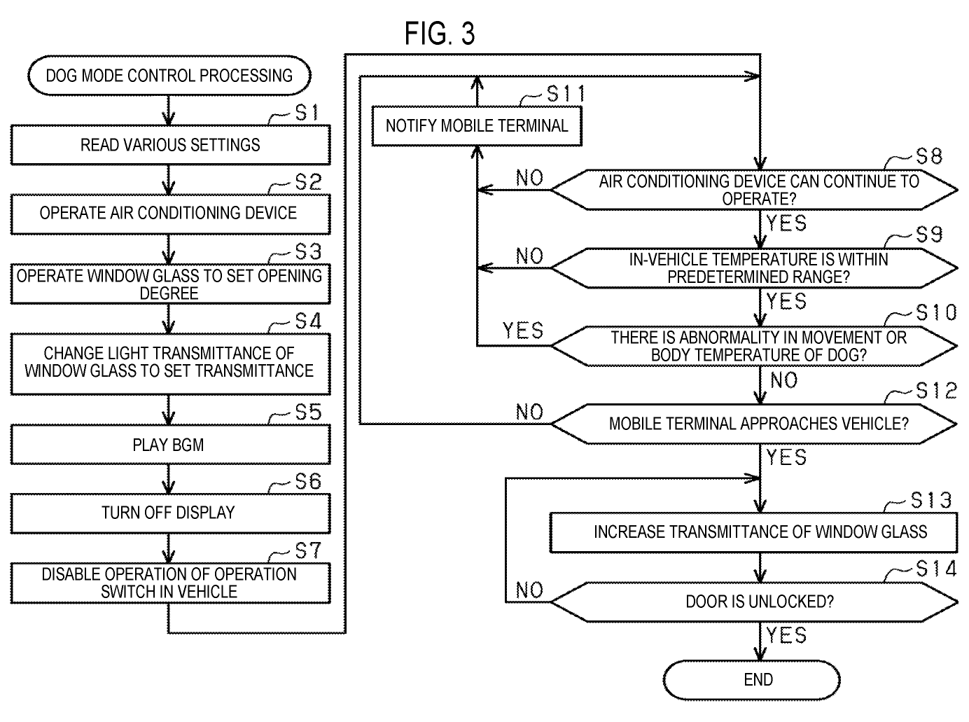

Next, a processing procedure of the dog mode control according to the present embodiment will be described with reference to FIG. 3. The series of processing is executed by the control device 80 in a case where the dog mode switch 31 is turned on.

As shown in FIG. 3, in a case where the dog mode control is started, first, various settings of the dog mode control are read (S1). The various settings include a set temperature and a set air volume by the air conditioning device 11, a set opening degree of the window glass 20, a set transmittance of the window glass 20, and BGM data played by the audio device 40.

Next, the air conditioning device 11 is operated such that the set temperature and the set air volume are obtained (S2).

Next, the window glass 20 is operated to the set opening degree by controlling the window glass motor 21 (S3).

Next, the power supply control of the window glass 20 is performed to change the light transmittance of the window glass 20 to the set transmittance (S4).

Next, the BGM is played by the audio device 40 (S5).

Next, the display 41 is turned off by stopping the power supply to the display 41 (S6).

Next, the operation of the operation switch 30 in the vehicle is disabled (S7).

Next, determination is made whether the air conditioning device 11 can continue to operate (S8). Here, for example, determination is made whether the air conditioning device 11 can continue to operate based on a battery remaining amount or a fuel amount in the fuel tank.

Here, in a case where determination is made that the air conditioning device 11 can continue to operate (S8: YES), next, determination is made whether the in-vehicle temperature measured by the in-vehicle temperature sensor 12 is within a predetermined range (S9). The predetermined range is a temperature range in which the dog that is the pet can comfortably spend time, and is, for example, a temperature range of 18 °C or higher and 25 °C or lower.

Here, in a case where determination is made that the in-vehicle temperature is within the predetermined range (S9: YES), next, determination is made whether there is an abnormality in the movement or the body temperature of the dog based on a detection result of the infrared camera 70 (S10). Here, determination is made whether there is an abnormality in the movement of the dog by machine learning or the like based on an image acquired by the infrared camera 70. In addition, determination is made whether there is an abnormality in the body temperature of the dog based on a temperature measured by thermography of the infrared camera 70.

Here, in a case where a negative determination is made in S8 and S9 and an affirmative determination is made in S10, next, the mobile terminal 90 is notified to prompt the occupant to return to the vehicle 10 (S11). Then, the processing of S8 to S10 is repeatedly executed.

On the other hand, in a case where determination is made that there is no abnormality in the movement or the body temperature of the dog (S10: NO), next, determination is made whether the mobile terminal 90 approaches the vehicle 10, that is, whether the occupant approaches the vehicle 10 (S12).

Here, in a case where determination is made that the mobile terminal 90 does not approach the vehicle 10 (S12: NO), the processing of S8 to S10 is repeatedly executed.

On the other hand, in a case where determination is made that the mobile terminal 90 approaches the vehicle 10 (S12: YES), the transmittance of the window glass 20 is increased (S13).

Next, determination is made whether the door is unlocked (S14). Here, determination is made whether the door is unlocked based on a signal from the door lock device 16.

Here, in a case where determination is made that the door is not unlocked (S14: NO), the processing of S13 is repeatedly executed.

On the other hand, in a case where determination is made that the door is unlocked (S14: YES), the dog mode control is ended on the assumption that the occupant has returned to the vehicle 10.

### Operation and Effect of Present Embodiment

(1) The control device 80 includes the storage unit 81 configured to store the set opening degree of the window glass 20 and the set transmittance of the window glass 20 during the execution of the dog mode control, and the controller 82 that executes the motor control such that the set opening degree is obtained and executes the power supply control such that the set transmittance is obtained in a case where the dog mode control is started.

According to such a configuration, in a case where the dog mode control is started, the opening degree of the window glass 20 is set to the set opening degree by the motor control, and the light transmittance of the window glass 20 is set to the set transmittance. Therefore, in a case where the set opening degree and the set transmittance are set according to the personality of the pet, the pet left in the vehicle is less likely to react to a person approaching the vehicle 10 or a noise outside the vehicle. Therefore, it is possible to contribute to reduction of stress on the pet left in the vehicle.

(2) The control device 80 includes the detection unit 83 configured to detect that the occupant approaches the vehicle 10. In a case where the detection unit 83 detects that the occupant approaches the vehicle 10 during the execution of the dog mode control, the controller 82 executes the power supply control such that the light transmittance of the window glass 20 is higher than the set transmittance.

According to such a configuration, in a case where the occupant approaches the vehicle 10, the occupant can check the state in the vehicle through the window glass 20 of which the light transmittance is increased higher than the set transmittance, and then open the door. As a result, it is possible to reduce sudden jumping out or falling off of the pet.

(3) The controller 82 is configured to disable the operation of the operation switch 30 in the vehicle during the execution of the dog mode control.

In a case where the pet is not placed in the cage, the pet may freely move in the vehicle, which may cause an erroneous operation of the operation switch 30.

In this regard, according to the above-described configuration, since the operation of the operation switch 30 in the vehicle is disabled during the execution of the dog mode control, it is possible to prevent the erroneous operation of the operation switch 30.

(4) The controller 82 operates the audio device 40 to play the BGM data during the execution of the dog mode control.

According to such a configuration, in a case where the BGM data is stored in advance in the storage unit of the audio device 40 such that the BGM on which the pet can calmly and comfortably spend time is played, the sound outside the vehicle is less likely to be recognized by the pet because the sound is mixed with the BGM. Therefore, it is possible to further contribute to reduction of stress on the pet left in the vehicle.

(5) The controller 82 stops the power supply to the display 41 during the execution of the dog mode control. As a result, it is possible to reduce the power consumption.

### Modification

The above embodiment can be modified and implemented as follows. The embodiment described above and the following modifications can be carried out in combination within a technically consistent range.
In the above-described embodiment, in a case where determination is made that the door is unlocked during the execution of the dog mode control, the dog mode control is ended. However, in a case where the dog mode switch 31 is turned off, the dog mode control may be ended.
The BGM data may not be played during the execution of the dog mode control.
The operation of the operation switch 30 may not be disabled during the execution of the dog mode control.
The detection unit 83 detects that the mobile terminal 90 carried by the occupant is close to the vehicle 10. Instead of this, a smart key (registered trademark) of the vehicle 10 that is configured to be communicable with the control device 80 may detect that the smart key is close to the vehicle 10.
In a case where the detection unit 83 detects that the occupant approaches the vehicle 10, the light transmittance of the window glass 20 may not be increased higher than the set transmittance.
The vehicle 10 may include a roof shade that is configured to be operated to cover a roof glass by motor control to be light-shieldable. The vehicle 10 may include a rear shade that is configured to be operated to cover a rear seat window glass by motor control to be light-shieldable. In this case, the storage unit 81 may be configured to store at least one of the set opening degree of the roof shade or the set opening degree of the rear shade during the execution of the dog mode control. The controller 82 may be configured to execute the motor control such that at least one of the roof shade or the rear shade is set to the corresponding set opening degree in a case where the dog mode control is started.

According to such a configuration, in a case where the dog mode control is started, at least one of the roof shade or the rear shade is set to the corresponding set opening degree by the motor control. Therefore, in a case where the set opening degree is set according to the personality of the pet, the pet left in the vehicle is less likely to react to a person approaching the vehicle or a noise outside the vehicle. Therefore, it is possible to further contribute to reduction of stress on the pet left in the vehicle.
The window glass 20 may not be a dimmable glass. In this case, the controller 82 may execute the motor control such that the opening degree of the window glass 20 is set to the opening degree setting value in a case where the dog mode control is started. According to such a configuration, in a case where the dog mode control is started, the opening degree of the window glass 20 is set to the set opening degree by the motor control. Therefore, in a case where the set opening degree is set according to the personality of the pet, the pet left in the vehicle is less likely to react to a person approaching the vehicle 10 or a noise outside the vehicle. Therefore, it is possible to contribute to reduction of stress on the pet left in the vehicle.
In the above-described embodiment, the dog mode control is executed based on the operation of the dog mode switch 31. Instead of this, the dog mode control may be automatically executed by detecting that the occupant is not present in the vehicle and that the pet is present by the infrared camera 70 or the like.
The pet that is the target of the dog mode control is not limited to a dog, and may be another pet such as a cat.

What is claimed is:

1. A vehicle control device configured to execute dog mode control of operating an air conditioning device of a vehicle in which an occupant is not present in a case where a pet is left in the vehicle, the vehicle including window glass that is opened and closed via motor control, the window glass being dimmable glass of which a light transmittance is changeable via power supply control, the vehicle control device comprising:
a storage unit configured to store a set opening degree of the window glass and a set transmittance of the window glass when the dog mode control is being executed; and
a controller configured to execute the motor control such that the set opening degree is obtained and execute the power supply control such that the set transmittance is obtained in a case where the dog mode control is started.

2. A vehicle control device configured to execute dog mode control of operating an air conditioning device of a vehicle in which an occupant is not present in a case where a pet is left in the vehicle, the vehicle including window glass that is opened and closed via motor control, the vehicle control device comprising:
a storage unit configured to store an opening degree setting value of the window glass when the dog mode control is being executed; and
a controller configured to execute the motor control such that the opening degree setting value is obtained in a case where the dog mode control is started.

3. The vehicle control device according to claim 1, further comprising a detection unit configured to detect that the occupant approaches the vehicle,
wherein the controller is configured to execute the power supply control such that the light transmittance of the window glass is higher than the set transmittance in a case where the detection unit detects that the occupant approaches the vehicle when the dog mode control is being executed.

4. The vehicle control device according to claim 1, wherein the controller is configured to disable an operation of an operation switch in the vehicle when the dog mode control is being executed.

5. The vehicle control device according to claim 2, wherein the controller is configured to disable an operation of an operation switch in the vehicle when the dog mode control is being executed.
